(19) United States
(12) Patent Application Publication
(10) Pub. No.: US 2004/0054778 A1
(43) Pub. Date: Mar. 18, 2004

(54) Method for charge settling service and system for charge settling service

(76) Inventor: Yoshihide Morioka, Tokyo (JP)

Correspondence Address: Jonathan P. Osha, ROSENTHAL & OSHA L.L.P., Suite 2800, 1221 McKinney Street, Houston, TX, 77010, US

(21) Appl. No.: 10/308,873

(22) Filed: Dec. 2, 2002

(30) Foreign Application Priority Data
Sep. 18, 2002 (WO) PCT/JP02/09548

(51) Int. Cl. G06F 15/173

(52) U.S. Cl. 709/225

(57) ABSTRACT

In a connection service section (101) in which an Internet connection providing service is provided, a wireless interconnecting device 1 is provided to constitute a wireless LAN. A user wirelessly connects a mobile personal computer (4) or a mobile terminal (5) of his/her own to the wireless interconnecting device (1) so that the mobile personal computer (4) or the mobile terminal (5) can be connected to a provider (102) via a router (2), which enables the communication with the Internet network (103). A point counting server (7) of the provider (102) calculates the number of points corresponding to the communication time or the communication amount of the mobile personal computer (4) or the mobile terminal (5) to notify the number of points to the router (2) in the connection service section (101) in response to a request from the user. A party providing the service can reflect the number of points in the charge to the user for his/her purchase of goods or the like in the connection service section (101).

### BACKGROUND OF THE INVENTION

1. Field of the Invention

The present invention relates to a technology for using the Internet, and particularly, to that realizing enhancement in convenience, economy, and so on not only of users but also of those providing services relating to the Internet.

2. Description of the Related Art

In recent years, in accordance with the progress in a network technology and so on in addition to the progress in a computer technology, especially, in a so-called personal computer technology, the Internet is becoming widely spread and used.

Under such circumstances, various usage forms of the Internet are being developed and put into practical use. As one example of these forms, in recent years, such an Internet connection providing service has been developed gradually which is available in a corner of a shop or a public facility and which enables a user visiting this place to establish a connection to the Internet from this place using his/her own mobile personal computer.

This Internet connection providing service is so structured that a wireless interconnecting device for a wireless LAN, which is generally called an access point, conforming to the specifications of, for example, IEEE (Institute of Electrical and Electronics Engineers)802.11a, IEEE802.11b, and so on is generally provided in the place where the service is provided, and this wireless interconnecting device is connected to a router, thereby enabling an external connection, namely a connection to the Internet. Further, it is so structured that the user brings in his/her own mobile personal computer provided with an adaptor for enabling the connection to the wireless interconnecting device and wirelessly connects this mobile personal computer to the access point to realize the connection to the Internet.

Such an Internet connection providing service is now available, for example, in restaurants such as so-called fast-food eateries, shops of other articles, hotels, public facilities, and so on, and in many cases, their primary businesses do not necessarily have direct relation to the Internet connection providing service. The primary purpose of using these shops represented by the purchase of the articles sold in the shops or the like does not have direct relation to the use of the Internet connection providing service, and the Internet connection providing service is only a subsidiary business. Hence, at present, those providing this service cannot fully enjoy the advantage of providing the service and the users do not fully enjoy the advantage of using the service.

### SUMMARY OF THE INVENTION

The present invention is made in consideration of the above situation, and it is an object of the present invention to provide a method and a system for charge settling service in an Internet connection providing service, these method and service bringing about more advantages both to those providing the Internet connection providing service and users thereof than in conventional ones.

It is another object of the present invention to provide a technology for using the Internet which is more attractive also to providers.

According to a first aspect of the present invention,

provided is a method for charge settling service in an Internet connection providing service which provides a connection environment to the Internet network using a wireless LAN access point, comprising the steps of:

converting a usage amount of the Internet connection providing service by a user into the number of points; and

reflecting the number of points in charge settlement for a user's usage of a different service or an article for sale which is provided by a party providing the Internet connection providing service together with the Internet connection providing service.

According to such a method, the usage amount of the Internet connection providing service is converted into the number of points so that this number of points can be reflected in the charge for the usage or the purchase of a different service or an article for sale provided in the same place by the party providing the Internet connection providing service, so that the usage by the user is further promoted. This results in an increased economic advantage and so on both for the party providing the service and the user thereof compared with a conventional method.

According to a second aspect of the present invention, provided is a system for charge settling service, comprising:

a wireless LAN access point enabling a client terminal to be connected to the Internet network via a provider;

a managing computer LAN-connected to the wireless LAN access point; and

a point counting server provided at the provider,

wherein the point counting server converts a usage amount from a start to an end of communication of the client terminal with the Internet network into the number of points to calculate this number of points, and notifies this calculated number of points to the managing computer in response to a request from the client terminal.

### BRIEF DESCRIPTION OF THE DRAWINGS

FIG. 1 is a block diagram showing a system configuration example in an embodiment of the present invention;

FIG. 2 is a flow chart showing a processing procedure executed in a mobile personal computer or a mobile terminal of a different kind owed by a user, in a first embodiment of a method for charge settling service;

FIG. 3 is a flow chart showing a processing procedure executed by a point counting server in the first embodiment of the method for charge settling service; and

FIG. 4 is a flow chart showing a processing procedure executed in a managing computer in a second embodiment of the method for charge settling service.

### DETAILED DESCRIPTION OF THE PREFERRED EMBODIMENTS

The present invention will be hereinafter described in detail with reference to the attached drawings.

It is to be understood that the present invention is not intended to be limited to members, dispositions, and so forth which will be described below, and various modifications and improvements may be made therein without departing from the spirit of the present invention.

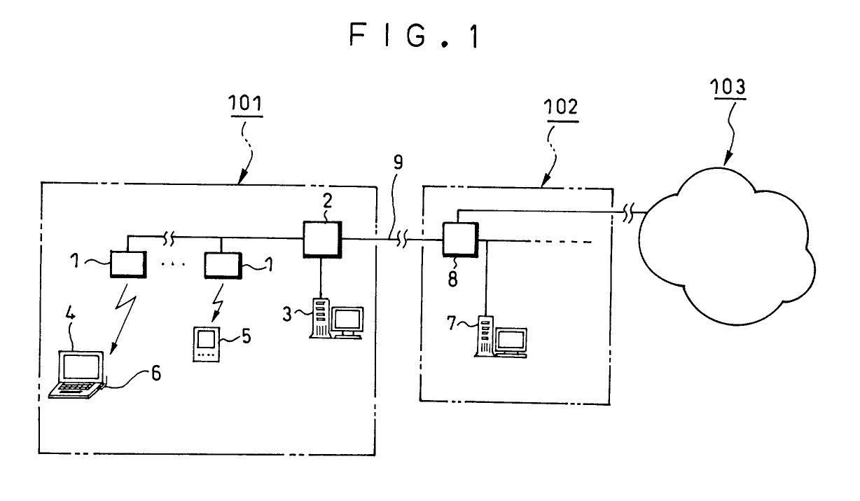

First, the configuration of a system for charge settling service in using an Internet connection providing service in an embodiment of the present invention will be explained with reference to FIG. 1.

To begin with, the present invention is applied to the Internet connection providing service which is now being put into practical use. The basic structure of the Internet connection providing service as a precondition of the present invention need not be a structure peculiar to the present invention, and a general structure which is in practical use now is sufficient. The present invention is realizable by adding a function (to be detailed later) mainly by software to the service having such a basic structure as a precondition.

More specifically, the Internet connection providing service is so structured that a wireless interconnecting device 1, more preferably, a plurality of wireless interconnecting devices 1, generally called a wireless LAN access point, is(are) provided in a section (hereinafter, referred to as a ‘connection service section’) 101 where, for example, refreshments, other goods, or other services are provided, to be more specific, a corner or the like inside a shop, a hotel, or a public facility, and these wireless interconnecting devices 1 are connected to a router 2 as an interconnecting device with an external network, thereby constituting a wireless LAN (refer to FIG. 1). A managing computer 3 functioning as a charge settling server is connected to the router 2.

Here, as the wireless interconnecting device 1, a wireless interconnecting device having a generally and conventionally known structure for constituting a wireless LAN, conforming mainly to the specifications of IEEE (Institute of Electrical and Electronics Engineers)802.11a, IEEE802.11b, or the like is appropriate.

Meanwhile, a user of this Internet connection providing service is required to bring in to this connection service section 101 a mobile personal computer 4 or a mobile terminal 5 of a different kind of his/her own as a client terminal, and as a precondition, each of them has a function of enabling the communication with the wireless interconnecting device 1. This communication function with the wireless interconnecting device 1 is generally realized by such a method, for example, that an adapter 6 for a wireless LAN is mounted on the mobile personal computer 4 or the other mobile terminal 5. The present invention, however, is not of course necessarily limited to such a form, and other conventionally and generally used methods may of course be used. Incidentally, in the embodiment of the present invention, the managing computer 3 is capable of wirelessly communicating with the wireless interconnecting device 1.

The router 2 has a conventionally and generally known structure provided with a function of packet interconnecting processing at a network layer level in an OSI reference model.

In the structure described above, the user of the Internet connection providing service establishes the communication between the mobile personal computer 4 or the other mobile terminal 5 of his/her own and the wireless interconnecting device 1 so that he/she can communicate with an external communication network, namely, the Internet network 103 via the router 2. More specifically, the router 2 provided in the connection service section 101 is connected to a leased line (or a public telephone line) 9 for the Internet connection providing service, thereby to be generally connected to an Internet service provider (hereinafter, referred to simply as a ‘provider’) 102 with which the user of the Internet connection proving service has entered into a contract and then connected to the Internet network 103 via this provider 102. Incidentally, the connection form is not limited to that described here, and the connection to the Internet network 103 may of course be established via a provider with which the party providing the Internet connection providing service has entered into a contract in advance.

Here, the configuration of the provider 102 shown in FIG. 1 shows only constituent elements directly involved in the realization of a method for charge settling service according to the present invention and other constituent elements are omitted in the drawing. Namely, the provider 102 basically has a conventionally and generally known configuration, and in the embodiment of the present invention, it is especially provided with a point counting server 7 necessary for realizing a later-described first embodiment of the method for charge settling service, the point counting server 7 being so structured to be connected to the router 2 of the party providing the Internet connection providing service via a provider-side router 8. Incidentally, it is not always necessary to newly dispose this point counting server 7 in the configuration of a general provider, and a later-described point counting function may be added to various kinds of other existing servers.

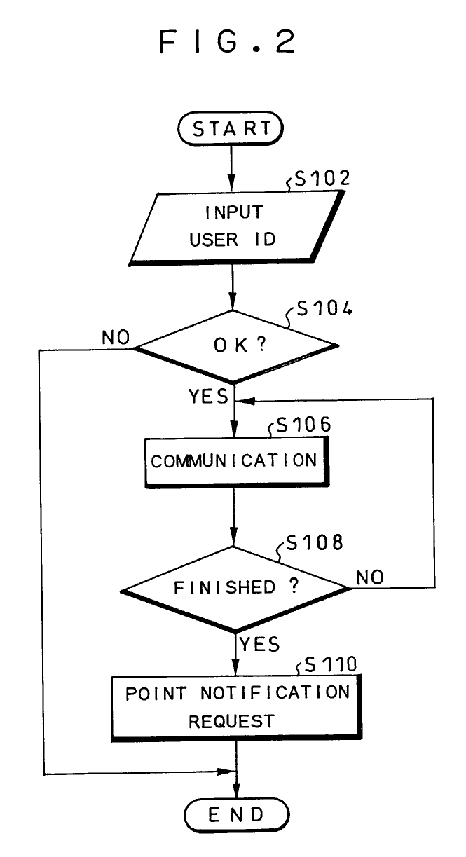

Next, a method for charge settling service according to the present invention which is embodied in the configuration described above will be explained with reference to FIG. 2 to FIG. 4.

To summarize the method for charge settling service according to the present invention first, it is so structured that a restaurant or the like which is run by the party providing the Internet connection providing service in the connection service section 101 is utilized, the communication time, the communication amount, or the like of the Internet connection providing service by the user is converted into the number of points, and this number of points is reflected in the charge to the user of the Internet connection providing service for the usage of the restaurants or the like when this charge is settled.

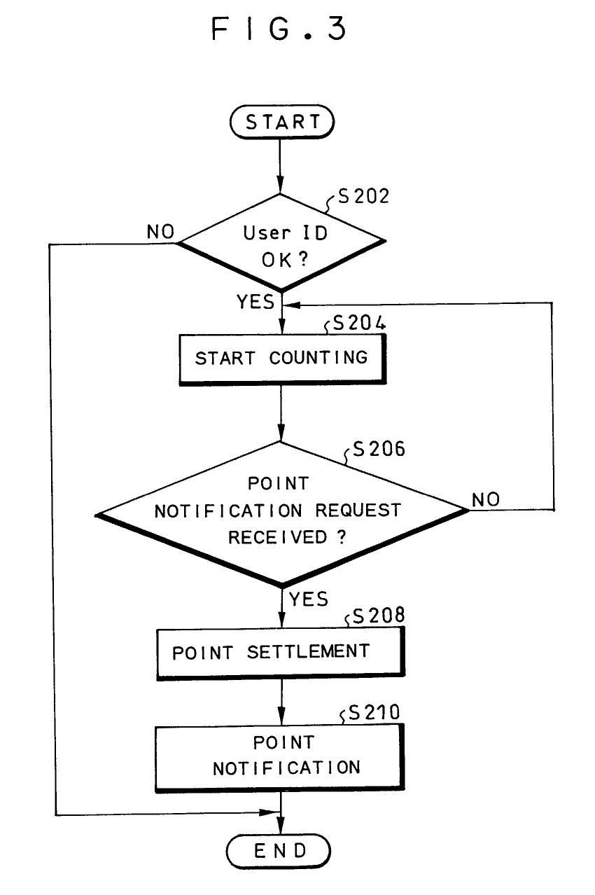

Next, the first embodiment of this method for charge settling service will be explained with reference to FIG. 2 and FIG. 3.

This first embodiment is especially characterized in that a user utilizes a provider with which the user has entered into a contract in advance and the number of points corresponding to the usage time (communication time) or the communication amount of the Internet is counted by this provider so that this number of points is available to the party providing the Internet connection providing service in charge settlement.

Specific explanation will be given below with reference to FIG. 2 and FIG. 3.

First, as a precondition, it is assumed that the mobile personal computer 4 or the other mobile terminal 5 owed by the user is in the state of having been normally connected to the wireless interconnecting device 1 and connected to the provider ordinarily used by the user (in other words, the provider with which the user has entered into a usage contract in advance). The provider 102 shown in FIG. 1 is assumed here for convenience' sake to be the provider with which the user has entered into a contract in advance.

Under such a precondition, to explain first the processing procedure for using the charge settling service executed in the mobile personal computer 4 or the other mobile terminal 5 of the user, the user, when starting the usage of the Internet network 103 via the provider 102, inputs a user identification code to the mobile personal computer 4 or the other mobile terminal 5 to transmit it to the provider 102 (refer to Step S102 in FIG. 2). Here, the user identification code is necessary for the provider 102 to identify the user of this method for charge settling service, and this user identification code is determined between the user and the provider 102 in advance when the user starts to utilize this charge settling service. As specific examples of this user identification code, for example, a credit card number, name, an identification number assigned in advance by the party providing the Internet connection providing service, and the like can be thought of. However, it need not be limited to a specific one of these examples and is to be selected in various manners in consideration of the user's convenience or the like.

In the provider 102, it is confirmed whether or not this user identification code is identical to a user identification code registered in advance, and the provider 102 transmits the result of the confirmation (a series of the processing procedure on the provider 102 side will be detailed later). In the mobile personal computer 4 or the other mobile terminal 5 of the user, the result of the confirmation for the user identification code thus transmitted from the provider 102 is received and it is judged whether or not this confirmation result shows that the user identification code is a proper one (refer to Step S104 in FIG. 2). Then, when it is judged in this Step S104 that the confirmation result shows that the user identification code is the proper one (YES), the communication with the Internet network 103 by the user via the provider 102 is started (refer to Step S106 in FIG. 2). When, on the other hand, it is judged in Step S104 that the confirmation result does not show that the user identification code is the proper one (NO), a series of the processing is finished to disable the user from establishing connection to the Internet using this charge settling service.

Then, after it is judged in Step S104 that the confirmation result shows that the user identification code is the proper one, the communication with the Internet network 103 is continued until a predetermined operation, a command input, or the like leads to the judgment that the communication is finished (refer to Steps S106 and S108 in FIG. 2). Then, when it is judged that the communication is finished (refer to Step S108 in FIG. 2), the mobile personal computer 4 or the other mobile terminal 5 transmits a point notification request to the provider 102, and in accordance with this request, the Internet connection using the charge settling service is finished (refer to Step S10 in FIG. 2).

Next, the processing procedure executed on the provider 102 side in response to the above-described operation of the computer 4 or the other mobile terminal 5 will be explained with reference to FIG. 3.

First, when the user identification code transmitted from the mobile personal computer 4 or the other mobile terminal 5 is received, it is judged in, for example, the point counting server 7 (or a different server or a managing computer, or the like) whether or not this user identification code is identical to that stored in advance as the identification code of the user of the charge settling service (refer to Step S202 in FIG. 3). Then, when it is judged in this Step S202 that this user identification code is not the proper one (NO), a series of the processing for this charge settling service is terminated. When, on the other hand, it is judged in Step S202 that this user identification code is the proper one (YES), the communication with the Internet network 103 by the mobile personal computer 4 or the other mobile terminal 5 via the provider 102 is started as described above, and therefore, in accordance with the start of the communication, the usage amount, more specifically, the communication time or the communication amount up to the end of the communication with the Internet network 103 by the mobile personal computer 4 or the other mobile terminal 5 is counted (refer to Steps S204 and S206 in FIG. 3).

Then, when it is judged that the point notification request from the mobile personal computer 4 or the other mobile terminal 5 is received, the point settlement is executed (refer to Steps S206 and S208). Here, this ‘point settlement’ means to calculate the number of points corresponding to the time or the amount of the communication of the mobile personal computer 4 or the other mobile terminal 5 with the Internet network 103 via the provider 102 based on a predetermined conversion standard. The ‘conversion standard’ is a standard for determining the number of points for the unit communication time or the unit communication amount, for example, determining that the communication time of 10 minutes is to be converted to 1 point. Incidentally, the ‘communication amount’ is, for example, a packet amount per unit time or the like.

Then, after the point settlement is executed, the calculated number of points is notified to the managing computer 3 in the connection service section 101 from the point counting server 7 (refer to Step S210 in FIG. 3).

The manner in which the party providing the Internet connection providing service reflects the number of points received in the managing computer 3 in the charge for the user's usage of the restaurant or the like in the connection service section 101 and the usage form thereof are not limited to specific forms and various forms can be taken.

More specifically, first, as a precondition, the minimum currency unit basically corresponds to, for example, 1 point or a plurality of points. As one of the usage forms, such a form can be thought of that the user of the Internet connection providing service uses the restaurant or the like run by the party providing the Internet connection providing service in the connection service section 101 and in settling the charge thereof, the amount of money corresponding to this number of points is deducted from the charge for his/her usage of the restaurant or the like.

Further, as a second usage form, such a form can be also thought of that the number of points is not reflected every time the charge for the usage of the restaurant or the like is settled, but the number of points is settled under a predetermined condition such as a predetermined period or a predetermined number of times, and when the predetermined condition is fulfilled, the amount of money corresponding to the settled number of points is deducted from the charge for the usage of the restaurant or the like.

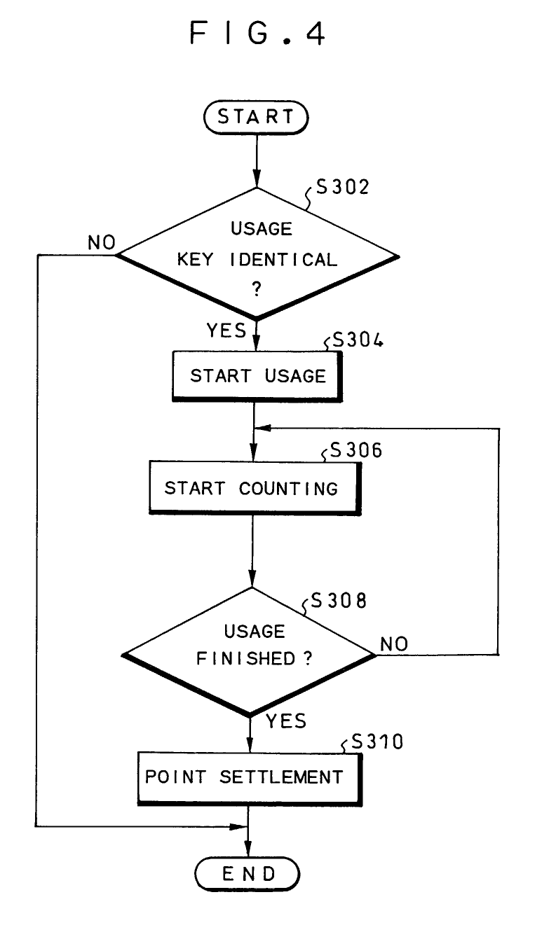

Next, a second embodiment of the method for charge settling service will be explained with reference to FIG. 4.

The system configuration in this second embodiment is basically the same as that shown in FIG. 1 except that the point counting server 7 in the configuration previously shown in FIG. 1 is not necessary.

Further, as a precondition, in this second embodiment, the party providing the Internet connection providing service in the connection service section 101 has entered into a contract regarding the Internet connection with the provider 102 in advance. Hereinafter, in this embodiment 2, the provider 102 is assumed to be the provider with which the party providing the Internet connection providing service has entered into a contract in advance.

In other words, in this second embodiment, unlike the above-described first embodiment, the user of the Internet connection providing service communicates with the Internet network 103 not via the provider which the user ordinarily uses, but communicates with the Internet network 103 using the provider 102 with which the party providing the Internet connection providing service has entered into a contract.

In such a structure, the user of the Internet connection providing service is supplied with a usage key from the party providing the service when using this service.

This usage key is for enabling the user in the connection service section 101 to establish the connection to the wireless interconnecting device 1 using the mobile personal computer 4 or the other mobile terminal 5 owed by the user and the connection to the provider 102 as well, and more specifically, as the most simple one, for example, a password can be thought of. In other words, in a method using this password, the password is issued for the user of the Internet connection providing service by the party providing the Internet connection providing service when the user uses this service, and the user inputs this password by himself/herself to start the connection to the wireless interconnecting device 1.

Alternatively, such a method is also usable that the user is loaned a USB key or one of various kinds of electronic information storage mediums such as a magnetic storage medium, an optical storage mediums, and the like on which the aforesaid password, predetermined conditions, and the like for starting the usage are stored in advance, and the user mounts this USB key or the like on the mobile personal computer 4 or the other mobile terminal 5 owed by him/her so that the contents thereof is read, and the recognition of this key or the like as a proper usage key in the managing computer 3 as is described later enables the use of the Internet.

Under such a precondition, when the user starts to access the wireless interconnecting device 1 using the aforesaid usage key, it is first judged in the managing computer 3 whether or not this usage key is the proper one (refer to Step S302 in FIG. 4), and when it is judged that this usage key is not the proper one (NO), a series of the processing is terminated to disable the user from communicating with the Internet network 103. When, on the other hand, it is judged in Step S302 that this usage key is the proper one (YES), the connection to the provider 102 is started to enable the user to communicate with the Internet network 103 via the provider 102 (refer to Step S304 in FIG. 4). Then, the counting of the communication time or the communication amount with the Internet network 103 used by the user is started at the same time in the managing computer 3 (refer to Step S306 in FIG. 4).

The counting of this communication time or the communication amount is continued until the communication with the Internet network 103 is finished by the user (refer to Step S308 in FIG. 4), and when it is judged that the communication is finished, the point settlement is made to finish a series of the processing (refer to Step S310 in FIG. 4). Here, the contents of the ‘point settlement’ are basically the same as those previously explained with reference to FIG. 3, and therefore, repeated explanation thereof will be omitted here.

Further, the form of reflecting thus calculated number of points in the charge for the user's usage of the restaurant or the like in the connection service section 101 is the same as that in the first embodiment previously explained with reference to FIG. 2 and FIG. 3, and therefore, repeated explanation thereof will be omitted here.

Incidentally, the aforesaid processing in Step S306 in the managing computer 3 can be omitted. More specifically, since the record of the communication time or the communication amount is generally stored in the router 2, the data stored in this router 2 may be taken into the managing computer 3 at the time of the point settlement (refer to Step S310 in FIG. 4).

Further, in any of the above-described embodiments, in order to reflect the number of points in the charge for the user's usage of the restaurant or the like in the connection service section 101, for example, such a method is also usable that a so-called cash register (not shown) for settling the charge for the user's usage of the restaurant or the like is connected to the managing computer 3, and the cash register reads the number of points calculated in the managing computer 3 so that this number of points can be reflected in the settlement of the charge for the usage. Alternatively, a function of the cash register may be added to the managing computer 3 so that the point settlement can be made and the number of points can be reflected in the settlement of the charge for the usage of the restaurant or the like.

As is described hitherto, according to the present invention, the amount of the usage of this service by the user of the Internet connection providing service can be reflected in the charge for the user's usage of the restaurant or the like where the Internet connection providing service is provided so that the use of the Internet connection providing service can be promoted synergistically with the sales of other services, goods, and so on provided in this place. Moreover, such an effect is brought about that an increased advantage in terms of economy is given at least both to the party providing the service and the user thereof.

Further, especially when the provider is determined by the party providing the Internet connection providing service, not only the party providing the service and the user thereof are given the increased economic advantage as stated above, but also the provider is given an increased economic advantage.

What is claimed is:

1. A method for charge settling service in an Internet connection providing service which provides a connection environment to the Internet network using a wireless LAN access point, comprising the steps of:
converting a usage amount of the Internet connection providing service by a user into the number of points; and
reflecting the number of points in charge settlement for user's usage of a different service or an article for sale which is provided by a party providing the Internet connection providing service together with the Internet connection providing service.

2. A method for charge settling service according to claim 1, wherein the number of points is calculated in a provider with which the user enters into a usage contract in advance and to which the user is connected via a wireless interconnecting device, and
wherein the calculated number of points is notified to a managing computer of the party providing the Internet connection providing service from the provider in response to a request from the user.

3. A method for charge settling service according to claim 1, wherein the number of points is calculated in a managing computer of the party providing the Internet connection providing service.

4. A method for charge settling service according to claim 3, wherein the user establishes connection to a wireless interconnecting device using a usage key prepared in advance by the party providing the Internet connection providing service to be allowed to use the Internet connection providing service.

5. A system for charge settling service, comprising:
a wireless LAN access point enabling a client terminal to be connected to the Internet network via a provider;
a managing computer LAN-connected to said wireless LAN access point, and
a point counting server provided at the provider,
wherein said point counting server converts a usage amount from a start to an end of communication of the client terminal with the Internet network into the number of points to calculate the number of points, and notifies the calculated number of points to said managing computer in response to a request from the client terminal.

6. A system for charge settling service, comprising:
a wireless LAN access point enabling a client terminal to be connected to the Internet network via a provider; and
a managing computer wirelessly communicating with said wireless LAN access point,
wherein said managing computer converts a usage amount from a start to an end of communication of the client terminal with the Internet network into the number of points and calculates the number of points.

7. A system for charge settling service according to claim 6, wherein said managing computer allows the client terminal to communicate with the Internet network using said wireless LAN access point only when a usage key used by the client terminal is identical to a usage key determined in advance.

8. A system for charge settling service according to claim 5 or claim 7, wherein said managing computer calculates a charge for user's usage of a different service or an article for sale which a party providing an Internet connection providing service provides together with the Internet connection providing service, and calculates an amount of money, which corresponds to the number of points of the user, to be deducted from the charge for the usage.

9. A point counting server, being provided in a provider and so structured to convert a usage amount from a start to an end of communication of a client terminal with the Internet network into the number of points, and to be capable of externally transmitting the number of points in response to a request from the client terminal.

10. A managing computer which is LAN-connected to a wireless LAN access point in an Internet connection providing service which provides a service for connecting a client terminal to the Internet network by providing the wireless LAN access point which enables the client terminal to be connected to the Internet network via a provider,
said managing computer being so structured to convert a usage amount from a start to an end of communication of the client terminal with the Internet network via the Internet provider into the number of points and to calculate the number of points.

11. A recording medium comprising a charge settling service program which is recorded thereon and executed by a client terminal in an Internet connection providing service which provides a connection service to the Internet network using a wireless LAN access point,
wherein said charge settling service program comprises the steps of:
confirming a usage permission from a provider;
starting communication with the Internet network after it is judged that the usage permission is given from the provider;
judging whether or not the communication with the Internet network is finished; and
requesting the provider for the number of points when it is judged that the communication with the Internet network is finished.

12. A recording medium comprising a charge settling service program which is recorded thereon and executed by a point counting server which is provided in a provider in an Internet connection providing service providing a connection service to the Internet network using a wireless LAN access point,
wherein said charge settling service program comprises the steps of:
counting a usage amount from a start to an end of communication of a client terminal with the Internet network;
converting the result of the counting into the number of points; and
notifying the number of points to a managing computer which is LAN-connected to the wireless LAN access point in response to a request from the client terminal.

13. A recording medium comprising a charge settling service program which is recorded thereon and executed by a managing computer which is LAN-connected to a wireless LAN access point in an Internet connection providing service which provides a connection service to the Internet network using the wireless LAN access point,
wherein said charge settling service program comprises the steps of:
counting a usage amount from a start to an end of communication of a client terminal with the Internet network via a provider; and
converting the usage amount into the number of points when the communication is finished.

14. A recording medium according to claim 13, comprising the charge settling service program which is recorded thereon,
wherein said charge settling service program further comprises the step of:
enabling the client terminal to be connected to the Internet network only when a usage key inputted by the client terminal is identical to a usage key registered in advance.
